(19) United States
(12) Patent Application Publication
(10) Pub. No.: US 2006/0207348 A1
(43) Pub. Date: Sep. 21, 2006

(54) Detecting torque

(76) Inventor: Manfred Brandl, Gratwein (AT)

Correspondence Address: FISH & RICHARDSON PC, P.O. BOX 1022, MINNEAPOLIS, MN, 55440-1022, US

(21) Appl. No.: 11/367,190

(22) Filed: Mar. 3, 2006

(30) Foreign Application Priority Data
Mar. 4, 2005 (DE) 102005010521.1
Mar. 9, 2005 (DE) 102005010932.2

(51) Int. Cl. G01L 3/00

(52) U.S. Cl. 73/862.331

(57) ABSTRACT

An apparatus for detecting torque affecting an axle includes a carrier system, located along the axle, and having a central detector segment and external detector segments. The central detector segment and external detector segments interacts such that rotary motion of an external detector segment results in axial motion of the central detector segment. A sensor detects relative motion of the central detector segment, and produces a differential signal following the relative motion.

### CLAIM TO PRIORITY

This patent application hereby claims priority to German Patent Application No. 102005010521.1 filed on Mar. 4, 2005, and to German Patent Application No. 102005010932.2 filed on Mar. 9, 2005. German Patent Application No. 102005010521.1 and German Patent Application No. 102005010932.2 are hereby incorporated by reference into this application as if set forth herein in full.

### BACKGROUND

This application relates to a device and process for registering torque that affects an axle, together with a detector located at the axle and an inductive sensor.

Such devices, also called torque sensors, and their accompanying processes, are known in most manifold embodiments and applications. Such sensors may be required for the direct and indirect measurement of the torque on axles. Torques that affect the driving axle are measured in machines and motor vehicles in order to efficiently control drive units, such as the driving wheels of a car with four-wheel-drive.

Different measurement principles are considered for the torque sensors, for instance optical, capacitive, inductive or magnetic principles. These principles are mostly based on detecting the torsion of an axle, which is caused by the torque affecting the axle. The measured torsion is converted to a measurement signal.

Patent DE 44 30 503 features a torque sensor with a strain gauge system. Similar systems may be implemented with piezo-detectors as piezo-resistances or surface wave components (SAW). The torsion of the axle is detected by components arranged accordingly. The signal transfer of the components to a signal unit takes place telemetrically. Reliable fastening or attachment of the sensor elements on the axle surface is critical in these systems. The attachment cannot be subjected to any or, at best, minor influences due to aging. These sensor systems are less accurate in case of high reliability demands, as is the case in the automobile industry.

Patent DE 101 61 803 A1 features an electromagnetic torque sensor, which utilizes the magneto-strictive effect of the elastic axle requiring torsion. The dielectric changes of a ferromagnetic axle are hereby detected on the bases of the torque exertions. Such sensors usually have a minor precision and are comparably expensive.

Patent DE 10 2004 012 256 A1 features a torque sensor with an input and output axle which are connected by means of a torsion rod. A cylindrical core is mounted on the teethed external peripheral surface of an end portion of the output axle showing a very large diameter, so that it can be shifted in an axial direction with respect to the output axle. A sliding pin protruding over the input axle engages in a spiral nut of the cylindrical core in peripheral direction of the end portion through a long slit. With regard to a torque moment affecting the end portion, the moment is transferred to the output axle via the torsion rod, so that the input axle and output axle relatively contort to one another and the cylindrical core is shifted in axial direction through the engagement of the sliding pin. This axial shift is detected via two spools, the inductances of which change in an anti-phased manner.

Signal evaluation takes place with the aid of a closed magnetic circuit and subsequently switched differential amplifier, which incorporate the inductivities. The manufacturing cost of this type of mechanical system made out of a cylindrical core, teethed end portion and sliding pin of the other axle is considerable. The precision, among other things, depends on the low play and frictional losses. Furthermore, the torque sensor is only suitable for two-part axles.

### SUMMARY

What is needed is a reliable and cost-effective system, e.g., method and apparatus, for detecting a torque moment affecting an axle.

Accordingly, described herein is a system (hereinafter referred to as “the system”) that provides a torque moment sensor with a high performance and efficiency, as well as high reliability and low cost. As a result, it is suitable for applications which set the highest demands, such as the automobile industry.

The system has the additional advantage that it enables a device with high temperature stability. All critical parts required for the dimensioning or sizing of the device can be made from the same material, for instance steel. Consequently, it is possible that temperature changes will not cause changes to the dimensions of the individual parts of the device and, as a result, do not effect a signal shift and signal change, respectively. This is particularly significant with respect to possible radial dimensional changes, which could influence an air gap between rotating and fixed parts of the device. Effects of the second order do not influence the sensor output signal.

The system has the additional advantage that the output signal of the device is differential so that parasitic effects, such temperature-dependent effects, do not have an influence on the measurement signal as a first approximation.

Another advantage of the system is that the device has a relatively simple construction and, as a result, is less affected by environmental influences such as moisture, dirt, oil and external fields. In addition, the system is not substantially affected by vibrations. The individual elements of the device have a minor weight with high stiffness or rigidity so that a measurement without reaction and without vibrations is possible in a simultaneously high sensitivity to accelerations.

The system can be mass-produced. A relatively low number of parts are needed for manufacture. The parts can be made out of thin-wall sheet metal and/or tubes and in the scope of a cost-favorable die-casting procedure. Simple mechanical steps such as pressing, rolling, folding or cutting, as well as punching may be used to process the sheet metal and tubes, respectively. Laser-cutting is possible too. Finally, the assembly of the individual parts of the device is relatively inexpensive.

The system enables a wireless transfer of torque moment information from a rotating axle to a static detection and control unit via magnetic flow. Thanks to differential signal processing, marginal changes of the radial air space, as well as further parasitic influences are taken into account.

A further advantage of the system is that, due to cooperation of its carrier and detector segments, torsion on the axle caused by effective torque is mechanically strengthened and is converted into a linear motion, which is subsequently inductively detected and measured. This results in precise measurements, since linear motions are easier and more precise to detect than complicated motions, such as rotation.

The system is advantageous in that it produces mechanical strengthening of rotary motion in a linear motion by dimensioning spring elements (springs), such as the spring pins and slits, its carrier system, and the number and angle of the spring elements with respect to the axial direction of the axle and of the detector coaxially placed on the axle.

Furthermore, the detector detects a torsion of the axle via elastic deformation of joint-free and friction-free spring elements so that resistance and precision of the device remain excellent even as it gets older.

Additionally, the system can be used both for single-piece axles and for divided axles.

Another advantage of the system is that it can easily adjust to different measurement requirements through selection of materials and of the individual parts. In this way, it is possible to manufacture a carrier system from non-ferromagnetic elastic material, while detector segments are made out of ferromagnetic material. Both elements can thus be selected so that they are similarly capable of dealing with temperature changes, and so that they can change according to temperature. These changes may be compensated by differential signal measurement and differential signal processing.

The system also enables an optimal dimensioning of a magnetic circuit thanks to the setup and the cooperation of the carrier system and the detector segments in connection with spools and slugs, respectively.

The system also enables a simple justification of device elements toward one another, as well as corresponding signal evaluation through differential signal evaluation. The output signal of the device becomes equal to zero when there is no torque affecting the axle.

The details of one or more examples are set forth in the accompanying drawings and the description below. Further features, aspects, and advantages of the system will become apparent from the description, the drawings, and the claims.

### DESCRIPTION OF THE DRAWINGS

FIG. 1, comprised of FIGS. 1a and 1b, shows a view of a device on an axle absorbing a torque and a top view of a detector.

FIG. 2 shows a display of a carrier system of FIG. 1.

FIG. 3, comprised of FIGS. 3a and 3b, shows views to clarify functioning of the carrier system of FIG. 2.

FIG. 4 shows another embodiment of a device for detecting torque.

FIG. 5, comprised of FIGS. 5a and 5b, shows housing and detector segments in the embodiment of FIG. 4.

FIG. 6, comprised of FIGS. 6a and 6b, shows a further embodiment of a carrier system in execution and a sectional view.

FIG. 7 shows an embodiment of an inductive sensor.

FIG. 8, comprised of FIGS. 8a and 8b, shows views that clarify functioning of the inductive sensor.

FIG. 9, comprised of FIGS. 9a and 9b, shows another embodiment of a device for detecting torque.

### DESCRIPTION

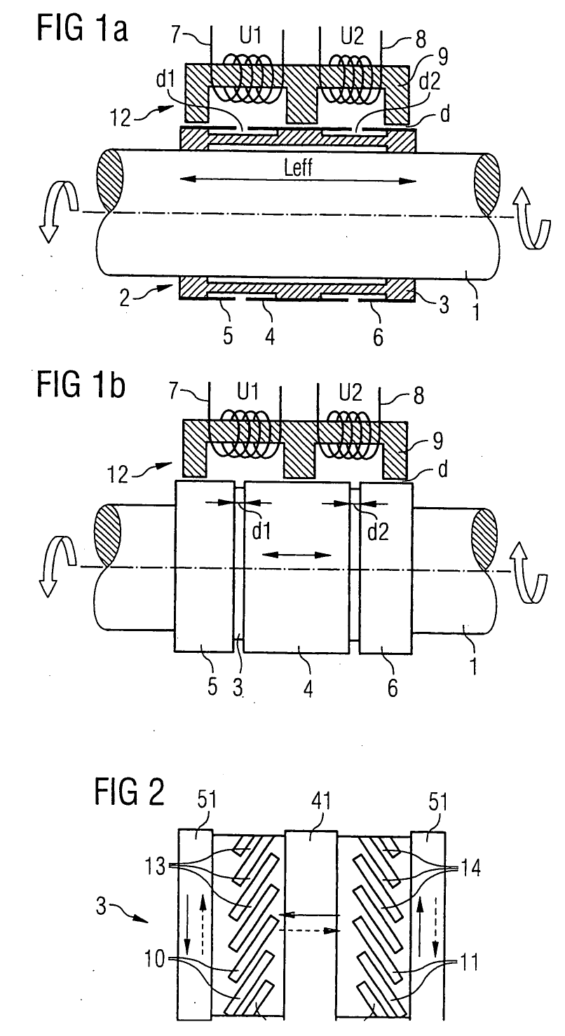

As shown in FIG. 1, a device for detecting torque, which includes a detector 2 and an inductive sensor 12, is represented on an axle 1. The device absorbs torque affecting the device and converts the torque into a torsion motion.

In this embodiment, the axle is one piece and a substantially constant diameter. The device is, however, usable with axles having different diameters, such as two-part axles.

Detector 2 is placed coaxially to the axle on axle 1. Detector 2 contains a carrier system 3, a central detector segment 4, and two external detector segments 5 and 6.

Carrier system 3 is shaped so that it absorbs the torsion of axle 1 and converts the torsion into a torsion motion of the external detector segments. To this end, carrier system 3 includes a case which is constructed so that its end areas are closely connected to the axle on the side of axle, while its central area is untouched by the axle. The carrier system, in accordance with the connection to the three detector segments, is structured in three segment zones on the side turned away from axle 1, which carry both external detector segments 5 and 6, as well as the central detector segment 4.

Thanks to the fixed connection of the end areas of carrier system 3 relative to axle 1, torsion of the axle is transferred to a rotary motion of the end areas of the carrier system and of the external detector segments, respectively. The setup of the carrier system ensures that rotary motion of the external detector segment zones of carrier system 3 are converted to an axial motion of the central detector segment zone and of the central detector segment 4. To this end, carrier system 3, which is placed coaxially to the axle in the embodiment according to FIGS. 1 and 2, includes spring elements 13, 14 formed through slits 10, 11 between the detector segment areas and the central segment area. Both series of spring elements 13, 14, which are placed in the shape of an angle on the axle of the detector 2 and of the axle 1, respectively, define the three segment areas and are reflected with respect to the cross axis of the detector. Spring elements 13, 14 can be elastically reformed as spring pins and transform the rotary motion of the external segment areas joint-free, play-free and friction-free to the central segment area.

The execution of the carrier system 3 according to FIG. 2 shows in carrier elements 41, 51 and 61 in the top view, onto which detector segments 4, 5 and 6 are mounted. Relative motions of carrier elements 41, 51 and 61 toward one another are determined by spring elements 13, 14. Since external elements 51 and 61 of the carrier system are connected to the axle on the side of the axle, a torsion motion of axle 1 transferred to the carrier system is represented through two arrows indicated across from the axial direction. The respective pulled through and dotted arrows are thereby assigned to one another.

Rotary motion of the external parts 51 and 61 is converted by the arrangement of the spring elements 13, 14 and slits 10 and 11, respectively, into a motion of the central segment area 41 in the direction of the longitudinal axis of the carrier system and of the axle 1, respectively. The slit areas are designed in such a way that the motion of the central area 41 is a linear motion in axial direction. Due to the selection of its material, the carrier system is elastically deformable, and returns to its starting position once the torque comes to an end. The geometrical relations of the slit areas between the segment areas 41, 51 and 61 determine the amplification factor of the mechanical transformation of the torsion motion of the external segment areas 51, 61, related to the central average segment area 41. The dimensioning of the spring elements and slits, respectively, is decisive in this case; in particular, their dimensions length to width, and the number, the angle with respect to the axial direction, and the distance between one another.

The carrier system may be made out of non-ferromagnetic elastic material, such as stainless steel, aluminum, ceramics or the like. The non-ferromagnetic carrier metal is functional in order to avoid a magnetic short-circuit and thereby permit operation of the magnetic circuit of the inductive sensor and of the metered value recording.

According to FIG. 1b in connection with FIG. 2, detector segments 4, 5 and 6 are fixed to three segment areas 41, 51 and 61 of carrier system 3, with which the actual wireless metered value transfer of the torque mechanically is converted to a linear motion in connection with the inductive sensor. The three detector segments are preferably tube-shaped and made out of ferromagnetic material. They are also coaxially fixed to the axle and the carrier system on the detector segment areas 41, 51 and 61 in the embodiment.

The relative axial motion of the central detector segment 4 related to the both external fixed detector segments 5 and 6 is detected by an inductive sensor 12. The sensor contains both spools 7 and 8, which produce two closed, differentially effective magnetic circuits in connection with E-shaped magnetic core 9 and detector segments 4, 5 and 6. Spools 7 and 8, as well as core 9 are stationary while detector segments 4, 5 and 6 rotate with the axle. The spool unit couples to the rotating part of the detector segments through the magnetic flow, which is constructed with the aid of the airspace d between the core 9 and the detector segments on the one hand, and d1, d2 between the detector segments 4, 5 and 6 among one another, on the other hand. The core 9 may be made out of ferromagnetic material, as is the case for detector segments.

According to FIG. 8a, the magnetic circuits run in the opposite direction of the central area and the external areas of core 9 through the airspace d towards the assigned external area of the rotating detector segment 5 and 6, respectively, and from here through the airspace d1 and d2, respectively, between the detector segments 5 and 6, respectively to the detector segment 4, as well as to the middle of the core 9.

Under normal conditions, in other words, without any affecting torques, the opposing tensions U1 and U2 which are caught between both spools, are equally large so that the differential output signal becomes zero. However, axial motion of the central detector segment 4 changes the balance of the magnetic flow so that the magnetic circuits are put out of phase. This produces an anti-phased change of the tensions U1 and U2, respectively, which lead to a differential signal differently from zero.

An output signal of the sensor can be generated via signal processing, which relates the difference of both sensor signals U1 and U2 to the sum of both signals. The differential signal can be related to the average value of both measurement signals. A sensor output signal may be generated in this manner, which is independent from fluctuations of the air space d between the core 9 and the detector segments.

Due to the setup of the carrier system, in which the detector segments are made out of ferromagnetic material and the carrier system includes non-ferromagnetic material, the magnetic circuits of the sensor can be substantially optimized without a magnetic short-circuit taking place. The detector segments and the carrier system may be made of materials which feature a similar temperature coefficient, or temperature coefficients that are close in value, in order to generate the smallest possible mechanical change in case of temperature changes. For example, the carrier system and the detector segments can be made of non-ferromagnetic and ferromagnetic steel.

In order to further improve the device and to increase its sensitivity, an evaluation switch (not shown) of the sensor signals may be used, which is capable of weakening or suppressing possible eddy currents.

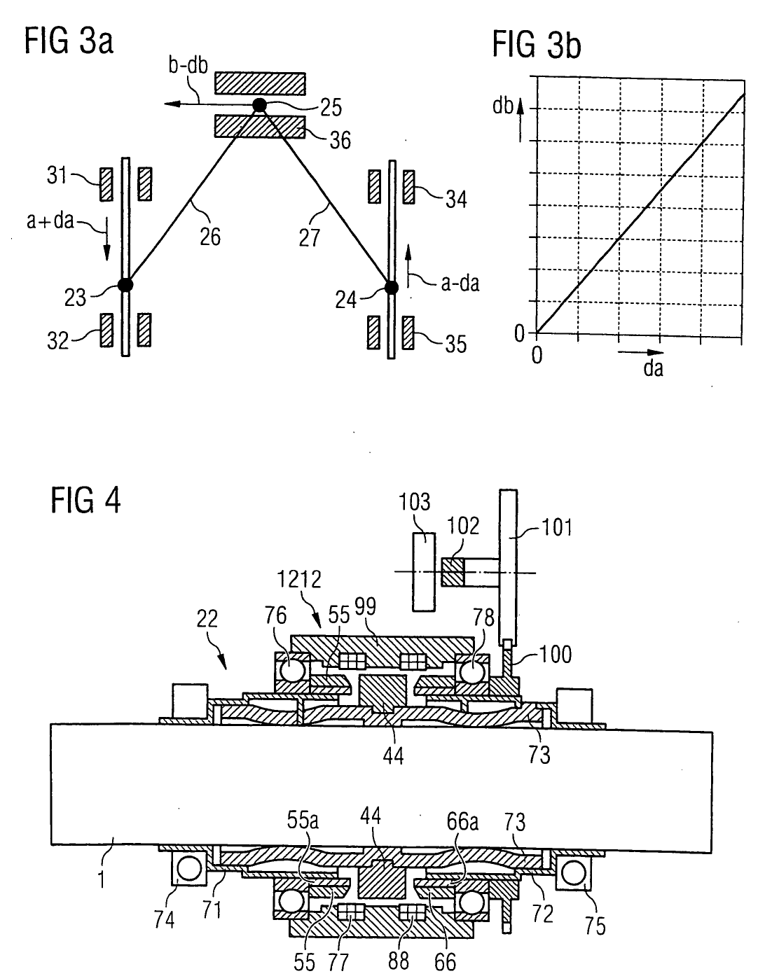

FIG. 3a shows mechanical transformation of the rotary motion of the external detector segments in a linear motion of the central detector segment based on a simplified model. This model assumes that three elements 23, 24 and 25, which symbolize the detector segments, are connected via bars 26 and 27. Elements 23, 24 and 25 can move along their action lines as indicated by guide bars 31, 32, as well as 34, 35 and 36. A change of the elements 23 and 24 from their rest position a takes place in the opposite direction so that element 23 changes by a value +da in a positive direction and the point 24 by a value −da compared to its rest positions. The motion of change is transferred by means of bars 26 and 27 to element 25, which subsequently executes a motion change −db in the direction indicated by the arrow compared to its rest position b. In case of a counter-rotating motion of elements 23 and 24 in the other direction, point 25 would be moved in the opposite direction by a positive value +db accordingly.

Although FIG. 3a is a simplified representation, the effects of a rotation of elements 23 and 24 can be represented on a motion of the element 25 via the simulation, FIG. 3b. The linear output signal can be recognized in this example. As studies have shown, the theoretical approach of the model corresponds well with the actual examples of the sensor as described herein.

Referring to FIG. 4, an embodiment of an assembled sensor is shown. In order to clarify the relation to the elements of FIGS. 1 and 2, the reference numbers in FIG. 4 have doubled compared to FIG. 1. Thus, rotating detector 22 is mounted on axle 1. Stationary part 1212 of the inductive sensor is assigned to the detector. Detector 22 contains two cases 71 and 72, which carry external ferromagnetic detector segments 55 and 66.

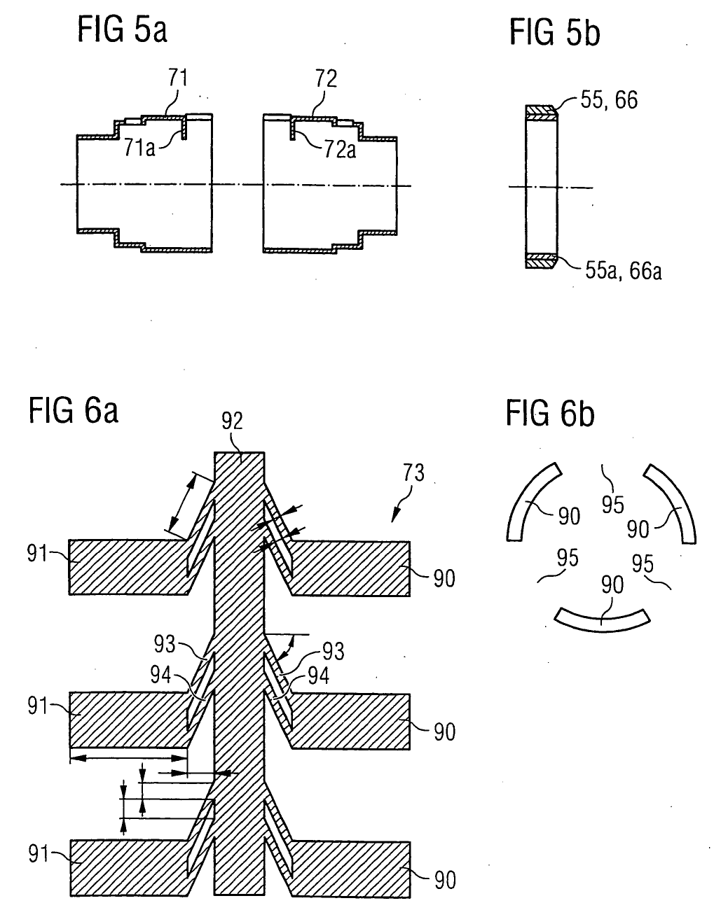

A corresponding case 71 and 72 is represented once more in greater detail in FIG. 5. Both housing parts and cases are identical and are assembled as laterally reversed on the central detector area on the axle. The cases can be made out of rolled, pushed and punched steel tube. The tube density depends on the dimensioning of the arrangement and can be between 0.5 and 1 mm in the embodiment. Thin-walled cases decrease eddy current losses. The alloys are selected in such a way that magnetic reversal losses are kept low. Cases 71 and 72 are secured in the embodiment with the aid of two clamps 74 and 75 on axle 1.

External detector segments 55 and 66 are mounted on the end side in the sensor area on the non-ferromagnetic housing part 71 and 72. Since the ring, which is mounted and secured on the case, is usually ferromagnetic, the detector segment is made out of a ring 55a and 66a, respectively, preferably out of aluminum and a ferromagnetic material 55 and 66, respectively, attached to that, FIG. 5b. The coating of the aluminum rings can be an iron powder filled with epoxy resin. The aluminum ring itself is used for insulation of the magnetic circuit of the carrier system.

Supports 76, 78 are placed between clamps 74, 75 and detector segments 55, 66. These supports carry the stationary inductive sensor part 1212 with the sensor spools 77 on the side turned away from the axle.

The central detector segment 44 of the detector is carried and secured by a shaped case 73. The case 73 is thereby shaped so that it can execute the mechanical transformation of the rotary motion of the external detector segments of the detector in the linear direction of the middle detector segment 44 of the detector. For this purpose, the case 73 features slits 95 (FIG. 6) on its external areas in which carriers 71a, 72a of housing 71, 72 intervene in order to produce a frictional connection between housing 71, 72 and carrier element 73. Mold casing 73 in the central area carries a ferromagnetic ring with the central detector segment 44. The ferromagnetic ring is connected with the central part of the case 73 in such a manner that no delamination occurs. An epoxy ring filled with ferromagnetic powder is one embodiment, which is formed on the central part of the case 73 or a ferrite ring that is attached. The central detector segment 44 extends in the radial direction to the same height as the external detector segments 55 and 66 and features on both sides an air space d1 and d2, respectively, for these elements. The stationary part of the inductive sensor with the core 99 and spools 77 and 88, also separated by an air space d, are located at a distance from the detector segments of the detector. The setup of the carrier system with the elements 71, 72, 73, 88a and 66a allows a particularly efficient decoupling of the sensor compared to the oscillations of the axle 1.

FIG. 6 shows an embodiment of the case 73 in a head-on section, as well as execution. The external segment areas 90, 91 are thereby each connected with the central segment area 92 via two spring pins 93, 94, which have a comparably longer dimensioning in the radial direction, in other words, vertical on the drawing level. As a result, an elastic connection between external areas 90, 91 and central area 92 is created, on the one hand, and a dimensioning is possible on the other hand in order to ensure rotary motion of parts 90 and 91 against one another in a linear direction of central carrier area 92. The possible dimensioning parameters are characterized by measurement arrows.

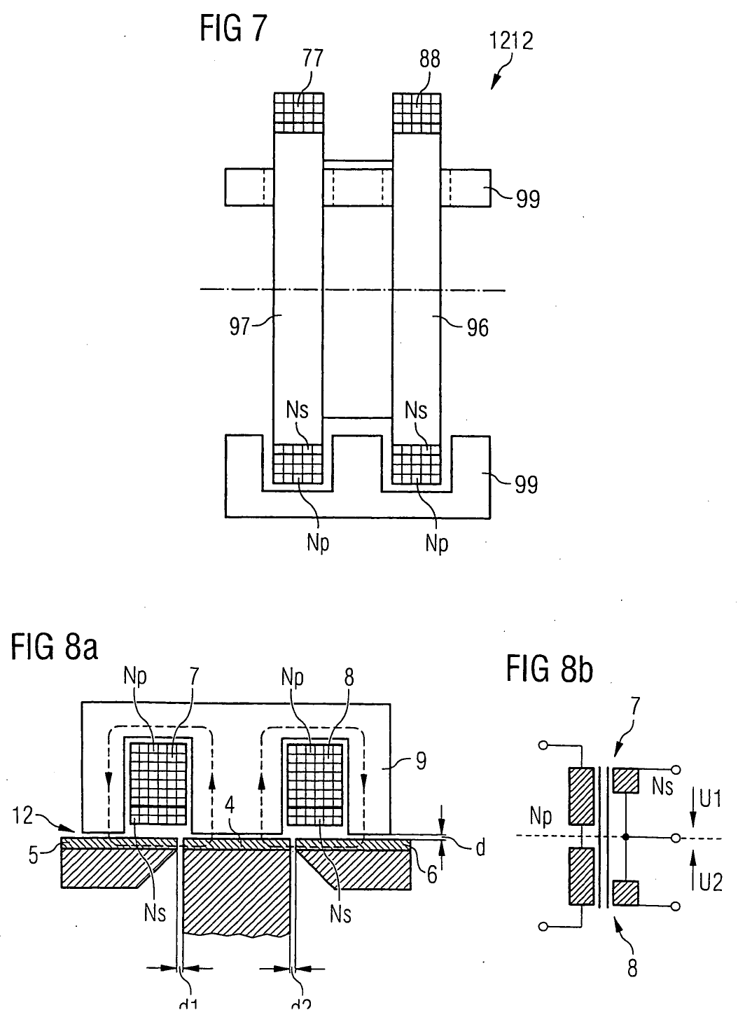

FIG. 7 shows a schematic setup of stationary inductive sensor element 1212. It has thereby been provided that spools 77, 88 are rolled up on two spool bodies 96 and 97 at a distance from one another. E-shaped ferrite cores 99 have been divided throughout the extent of the sensor element in order to be able to achieve a sufficient magnetic flow. The secondary coils Ns of the spools are placed close to the detector segments in a radial direction in the embodiment, while the primary coils Np, which generate the magnetic flow, are placed on the side turned away from the axle (see also FIG. 8a).

An electrical equivalent circuit diagram of the primary coils Np and of the secondary coils Ns of both spools 77 and 88 is demonstrated by FIG. 8b.

A rotation angle sensor is provided in addition to the torque sensor. A toothed wheel 100 is placed on the case 72, which clamps into another toothed wheel 101. The toothed wheel 101 carries a magnet on its axle which also rotates when axle 1 is rotating. The rotation angle of the magnet 102 is detected with a sensor 103 and converted into a measurement signal.

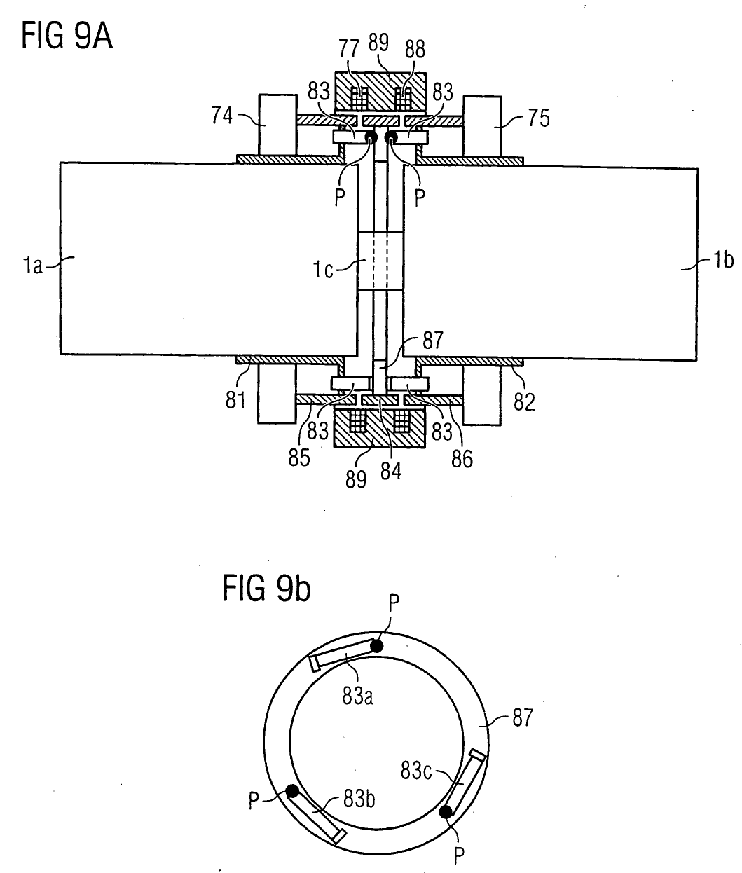

FIG. 9 shows another embodiment in which the carrier system contains two housing elements 81 and 82, which are constructed as cases, on an axle. As is evident from the embodiment of FIG. 4, the cases are, on the outside, fixed with clamps 74 and 75 on the axle. The cases stretch away from the axle in a ring and flange-shaped manner in the central area of the carrier system. The external ends of the ring-flange-type case areas, which are turned away from the axle, carry the external detector segments 85 and 86. A ring 87 is placed between the ring-flange areas of the cases 81 and 82. This ring carries detector segment 84 on its side turned away from the axle.

In this embodiment, detector segments 84, 85 and 85 have the same radial distance from the axle and are separated among one another in axial direction through a circular gap. Ring 87 of the carrier system is, with regard to the flange-type case end area, secured via spring elements and spring rods 83 (83a, 83b, 83c), respectively, which connect central ring element 87 with assigned end elements of cases 81 and 82, respectively. The definition of the ring level diagonal to the axle of the carrier system and axle, respectively, occurs in the embodiment via three spring rods 83 to the assigned case 81 and 82, respectively. The spring rods may be laterally reversed on both ring-shaped carriers 87.

Springs 83 carry, on the one hand, ring 87 and cause, on the other hand, a motion of the ring in the axial direction when the cases 81 and 82, respectively, rotate against one another based on a torque. As already shown in the embodiment of FIG. 1, central detector segment 84 shifts in axial direction, which shift is detected via inductive sensor and spool system 77, 78 and E-core 89 (as described above), and is converted into a measurement signal.

The form of the springs 83 between case elements 81, 82 and the central carrier element 87 can be adjusted according to the desired embodiment of the measurement conditions. In this way, the spring rods 83 can create, not only as is shown, a straight-line connection between the internal carrier system and the case end parts. The spring rods 83 can rather also run in a curve, adjusted to the axle size, to the case end parts. Finally, the spring rods can be rolled up internally. In any event, on the one hand, the carrier system should have sufficient stiffness or rigidity and, on the other hand, convert a rotary motion of cases 81, 82 against one another to a linear and axial direction of central detector segment 84 compared to external detector segments 85, 86. The form and number of attachments between the internal carrier element and the external cases of the carrier system determine the sensitivity of the torque sensor.

From a technical production point of view, the detector can be manufactured relatively easily. Cases 81, 82 of the carrier system can be made out of pressed stainless steel tubing. Central ring 87 of the carrier system be punched stainless steel. The external and central detector segment 84, 85 and 86 can be made out of cylindrical steel tubes with no or, if the case may be, a low amount of carbon. Springs 83 that connect the carrier system can include steel tape, which is welded via spot welding connections P with the cases 81, 82 and the central ring element 87. The springs can subsequently be welded on the ring 87. Afterwards, the springs may be pushed through corresponding slits of the cases 81, 82 and also spot welded with these cases.

The embodiment of FIG. 9 permits manufacture of a torque sensor in large quantities at industrial level. It can be simply adjusted to different measurement conditions, whereby, on the one hand, springs 83 are selected and shaped accordingly. In order to further increase the sensitivity of the system, the torque sensor according to FIG. 9 is suited particularly for a two-part axle, which absorbs and secures a case element 81 or 82 on its ends. Both axle elements 1a and 1b can be connected through a torsion bar 1c of a diameter that is lower than the axle itself, which features a lower stiffness or rigidity than the axle itself.

When dimensioning or sizing the inductive sensor, losses, which can emerge as resistive losses, magnetization losses or eddy current losses, should be small.

1. An apparatus for detecting torque affecting an axle, comprising:
a carrier system comprising a central detector segment and external detector segments, the carrier system being located along the axle, the central detector segment and external detector segments interacting such that rotary motion of an external detector segment results in axial motion of the central detector segment; and
a sensor to detect relative motion of the central detector segment, and to produce a differential signal following the relative motion.

2. The apparatus of claim 1, wherein the central detector segment and external detector segments interact such that rotary motion of an external detector segment results in axial motion of the central detector segment that is amplified.

3. The apparatus of claim 1, wherein the relative motion of the central detector segment is substantially joint-free and substantially friction-free.

4. The apparatus of claim 1, wherein the carrier system comprises a material that is elastic and non-ferromagnetic.

5. The apparatus of claim 1, wherein the carrier system comprises a case that is mounted on an end of the axle using spring elements.

6. The apparatus of claim 5, wherein the case comprises multiple parts.

7. The apparatus of claim 5, wherein the spring elements of the case are at an angle relative to an axial direction corresponding to a direction of the axle.

8. The apparatus of claim 5, wherein the spring elements define detector segment areas, and wherein spring elements between different detector segments are in a mirror-image configuration.

9. The apparatus of claim 1, wherein at least one of the central detector segment and the external detector segments comprises a ferromagnetic material.

10. The apparatus of claim 8, wherein the central detector segment and the external detector segments are each located in a segment area.

11. The apparatus of claim 1, wherein the central detector segment and the external detector segments are co-axial and arranged relative to the axle.

12. The apparatus of claim 1, wherein the sensor comprises an inductive sensor, the inductive sensor comprising stationary spool systems that are each in a closed magnetic circuit with at least one of the central detector segment and the external detector segments.

13. The apparatus of claim 12, wherein, absent torque of the axle, each spool system exerts an equal, but opposite, tension.

14. A method of detecting torque affecting an axle, the method being performed using a central detector segment, external detector segments, and a sensor, where the central detector segment and external detector segments are axially-aligned and configured to interact so that rotary motion of at least one external detector segment results in axial motion of the central detector segment, the method comprising:
rotating the axle, thereby causing the external detector segments to rotate and the central detector segment to exhibit axial motion;
detecting relative motion of the central detector segment via the sensor; and
produce a differential signal via the sensor following detecting.

15. The method of claim 14, wherein the central detector segment and external detector segments interact such that rotary motion of an external detector segment results in axial motion of the central detector segment that is amplified.

16. The method of claim 14, wherein the relative motion of the central detector segment is substantially joint-free and substantially friction-free.

17. The method of claim 14, wherein the sensor comprises an inductive sensor, the inductive sensor comprising stationary spool systems that are each in a closed magnetic circuit with at least one of the central detector segment and the external detector segments.

18. The method of claim 16, wherein, absent torque of the axle, each spool system exerts an equal, but opposite, tension.
